(19) United States
(12) Patent Application Publication
(10) Pub. No.: US 2008/0067717 A1
(43) Pub. Date: Mar. 20, 2008

(54) Apparatus for creating textured concrete surfaces

(76) Inventor: Michael Lampignano, Arlington Heights, IL (US)

Correspondence Address: MCANDREWS HELD & MALLOY, LTD, 500 WEST MADISON STREET, SUITE 3400, CHICAGO, IL, 60661, US

(21) Appl. No.: 11/521,735

(22) Filed: Sep. 15, 2006

(51) Int. Cl. B29C 59/04; B29C 53/20

(52) U.S. Cl. 264/293; 425/367; 425/385; 425/402

(57) ABSTRACT

Embodiments of the present invention relate to a roller apparatus for creating texture in concrete surfaces. The roller apparatus may include a roller body that is operably connected to an attachment mechanism. The roller body may include an outer surface and an inner surface. The outer surface may include at least one generally inward depression. Portions of the outer surface adjacent to the depressions may be relatively smooth. In one embodiment, the roller body may not be formed with, or operably connected to, outwardly extending protrusions that are intended to imprint textures into the concrete surface. The depressions may have a variety of shapes or provide information. The depressions may also be oriented in the roller body so as to create a desired pattern. The attachment mechanism may include hubs or spindles that may be operably attached to an attachment bracket by an axle or pin.

### BACKGROUND OF THE INVENTION

The present invention pertains to an apparatus for creating truncated domes, patterns, bumps, ridges, or designs (hereinafter collectively “texture”) on concrete surfaces. In particular, the present invention relates to a roller apparatus having a roller body, the roller body having an outer surface and an inner surface. The outer surface may include at least one depression that is configured to allow partially cured or pre-cured (hereinafter collectively “pre-cured”) concrete to be pressed or flow into the depression while allowing adjacent pre-cured concrete to remain relatively smooth or flat, thereby creating a texture on the concrete surface. Moreover, according to one embodiment of the present invention, the roller body may not include, or be operably connected to, outwardly extending protrusions that are used by known roller devices for imprinting or forming textures on pre-cured surfaces.

Textured concrete surfaces formed or shaped through the use of the apparatus of the present invention, such as truncated domes, may provide a detectable warning or alert pedestrians, particularly those who may be visually impaired or elderly, that they may be approaching the edge of a curb ramp and/or entering into a street. Such textured surfaces may also improve traction on the concrete surface. Moreover, the textured concrete surface may improve the ability of surfaces pressed against or along the concrete surface, such as the feet or shoes, to grip the concrete surface. Further, textured concrete surfaces created by the present invention may help individuals from falling or slipping on wet, icy, or inclined concrete surfaces. The increased traction or resistance created by a textured concrete surface formed by the apparatus of the present invention may also be beneficial to handicapped individuals. For example, on inclined surfaces, including, but not limited to, handicapped ramps and curb-to-sidewalk inclines, the additional traction or resistance provided by the inclusion of a textured surface formed or shaped by the present invention may resist a walking or movement aid, such as a wheelchair, walker, crutches, or cane, from slipping. Further, the depression of the present invention may be configured to form textured surfaces that relay information, such as advertising, directions, location information, company logos, and/or trademarks.

Examples of known roller apparatuses used for texturing concrete are those that have protrusions, ridges, or raised patterns extending outwardly from the roller body. Those protrusions are used to imprint or shape desired patterns or texture in pre-cured concrete surfaces. The protrusions of such apparatuses may be forced downwardly into the pre-cured concrete so as to move or compact the concrete impacted or affected by the insertion of the protrusion. In other instances, the protrusions may be formed through the use of a second body or individual pieces that operably connect to, or wrap around, at least a portion of, the roller body. Yet, the addition of protrusions to such roller apparatuses, whether through mechanical attachments or the construction of a second body, can increase material and fabrication costs. Further, cleaning these roller apparatuses is important so that dried concrete debris, which could adversely impact the uniformity of the desired pattern created on the concrete surface, or be dislodged into pre-cured cement, does not accumulate on the roller apparatus. Yet, the inclusion of protrusions on a roller body may add walls, corners, edges, and/or ridges along the roller body that may increase the difficulty of cleaning these roller apparatuses.

Thus, a need exists for an efficient and cost-effective roller apparatus for creating textured concrete surfaces.

### BRIEF SUMMARY OF THE INVENTION

Embodiments of the present invention relate to creating texture on concrete surfaces. In particular, the present invention pertains to a roller apparatus that may include a roller body that is operably connected to an attachment mechanism. The roller body may include an outer surface and an inner surface. The outer surface may include at least one generally inward depression. The remaining portions of the outer surface may be relatively smooth. Moreover, in one embodiment of the present invention, the roller body may not be formed with, or operably connected to, outwardly extending protrusions that are intended to imprint textures into the pre-cured concrete surface. To the contrary, in some embodiments, the outer surface of the roller body may undergo different processes, such as, but not limited to, turning, polishing, buffing, or grinding, in an attempt to minimize or eliminate instances of surface imperfections that may form undesired outwardly extending protrusions.

The roller apparatus of the present invention may use a variety of different shaped depressions, including truncated domes, text characters, numerical characters, trademarks, logos, illustrations, or a combination thereof. Further, the depressions may be oriented in the roller body so as to create desired patterns, including, but not limited to, square and triangular patterns. The depressions may also include an inner opening that allows excess concrete that passes into the depression to proceed into the inner portion of the roller body for later removal or re-application.

When in use, the roller apparatus of the present invention may be rolled along or across the pre-cured cement. The weight of the roller apparatus and/or force exerted generally downward on the roller apparatus may force at least a portion of the concrete beneath the roller body to flow or be pushed up into the depression. Sufficient force or weight of the roller apparatus is preferably exerted against the pre-cured concrete so that the entire depression may be filled with concrete, thereby allowing for the formation of the entire desired shape by the depression. Additional weight may be added to the roller apparatus, including the roller body, to assist in attempting to ensure that sufficient force is exerted on the pre-cured concrete surface so that an appropriate amount of pre-cured concrete goes into the depression. At least a portion of the concrete remaining beneath the roller body that does go into a depression may be flattened or smoothened by the smooth portion of the roller body.

### BRIEF DESCRIPTION OF SEVERAL VIEWS OF THE DRAWINGS

FIG. 1 illustrates a front view of a roller apparatus having a plurality of depressions for creating textured concrete surfaces according to an embodiment of the present invention.

FIG. 2 illustrates a side perspective view of a roller apparatus having a plurality of depressions for creating textured concrete surfaces according to an embodiment of the present invention.

FIG. 3 illustrates a front view of a roller body having a removable sleeve configuration according to an embodiment of the present invention.

FIG. 4 illustrates a perspective view of a plurality of depressions positioned along a metal sheet that may be used in fabricating a roller body according to an embodiment of the present invention.

FIG. 5 illustrates a side cross-sectional view of an individual depression having a dome-shaped configuration according to an embodiment of the present invention.

FIGS. 6A and 6B illustrate a plurality of depressions arranged in square and triangular patterns, respectively, according to embodiments of the present invention.

FIG. 7 illustrates a perspective view of a ramp having a textured surface created using a roller apparatus with dome-shaped depressions arranged in a square pattern according to an embodiment of the present invention.

FIG. 8 illustrates a perspective view of a ramp having a textured surface created using a roller apparatus with dome-shaped depressions arranged in a triangular pattern according to an embodiment of the present invention.

The foregoing summary, as well as the following detailed description of the preferred embodiments of the present invention, will be better understood when read in conjunction with the appended drawings. For the purpose of illustrating the preferred embodiments of the present invention, the drawings depict embodiments that are presently preferred. It should be understood, however, that the present invention is not limited to the arrangements and instrumentality shown in the attached drawings.

### DETAILED DESCRIPTION OF THE INVENTION

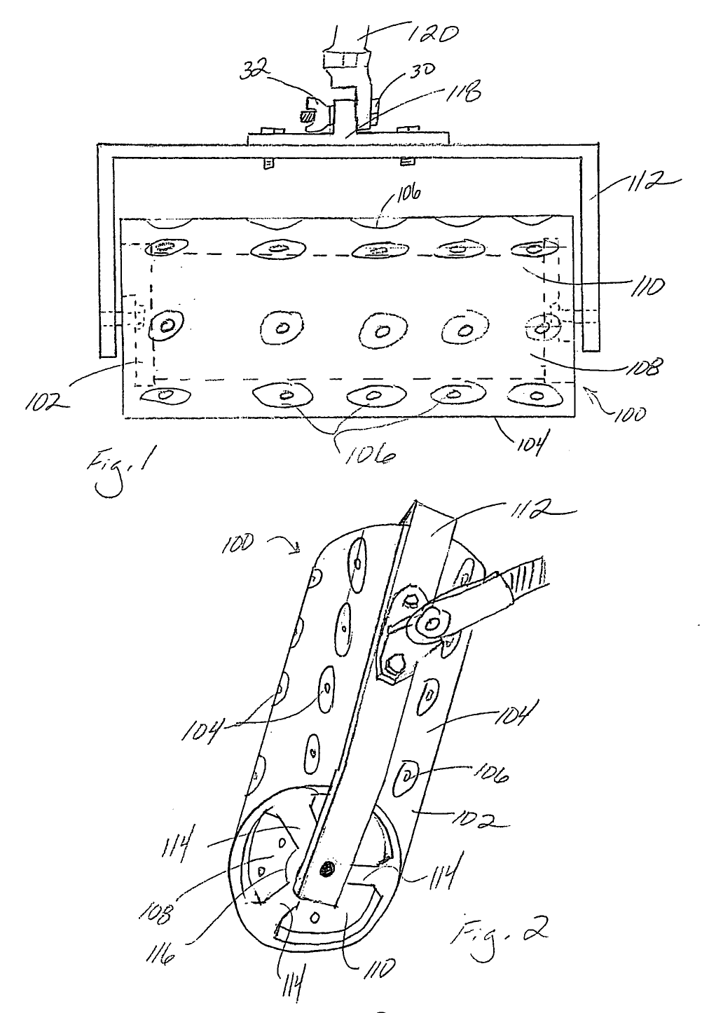

FIG. 1 illustrates a front view of a roller apparatus 100 having a plurality of depressions 106 for creating textured concrete surfaces according to an embodiment of the present invention. The roller apparatus includes a roller body 102, the roller body 102 having an outer surface 104 and at least one depression 106. Except for the depressions 106, as shown in FIG. 1, the outer surface 104 may be relatively smooth. In the illustrated embodiment, other than general surface irregularities or imperfections in finish or smoothness from fabrication, the outer surface 104 preferably does not include, or is not operably connected to, protrusions that extend outwardly away from the outer surface 104 that are intended to impart texture on the pre-cured concrete surface. Moreover, portions of the outer surface 104 adjacent to the depressions 106 may be polished, buffed, filed, or undergo grinding to remove or reduce surface irregularities or protrusions that may extend outwardly away from the outer surface 104. However, in alternative embodiments of the present invention, protrusions may be part of, or operably connected to, the roller body 102.

In the embodiment illustrated in FIG. 1, the roller body 102 has a generally tubular configuration that includes an inner surface 110 and a hollow inner portion 108. In other embodiments of the present invention, the inner portion 108 may be at least partially occupied or filled by additional materials or compartments that may add weight to the roller apparatus, including, but not limited to, lead weights or compartments that may hold solids or liquids, such as sand and/or water. Further, at least a portion of the inner portion 108 may be occupied by a portion of an attachment mechanism, which may include a hub or axle that may be operably connected to an attachment bracket 112. The attachment bracket 112 may be operably connected to a handle connector 118, such as through the use of a weld, bolts, or screws. The handle connector 118 may be operably connected to a handle 120, such as for example through the use of the bolt 30 and mating wing nut 32, as illustrated in FIG. 1. The angle of attachment between the handle 120 and handle connector 118 may be adjusted before being tightened together by the bolt 30 and wing nut 32. The handle 120 may be sized and configured so that a user may be able to roll the roller apparatus 100 across or along a pre-cured concrete surface. Additionally, the attachment bracket 112 and handle 120 may provide additional locations for the addition of weight(s), which may be added to increase the force exerted by the roller apparatus 100 against the pre-cured concrete surface.

FIG. 2 illustrates a side perspective view of a roller apparatus 100 having a plurality of depressions 106 for creating textured concrete surfaces according to an embodiment of the present invention. As shown, in one embodiment, the roller body 102 may be operably connected to a hub and/or spokes 114. For example, spokes 114 may be welded to the side portion or inner surface 110 of the roller body 102. The spokes 114 may terminate at a spoke hub 116. The spoke hub 116 may be operably connected to the attachment bracket 112 through an axle or pins. The spoke hub 116 and/or the attachment bracket 112 may also include a bearing that is operably connected to the axel or pin, whereby the bearing may improve the ease with which the roller body 102 may be rotated as it rolls across the pre-cured concrete surface. Alternatively, at least one hub may be operably connected to the end of the roller body 102 through the use of mechanical attachment, including, but not limited to, through the use of screws, bolts, nuts, and tapers. Additionally, the hub may be a threaded end cap that mates an internal thread that is positioned along, or operably connected to, the roller body 102.

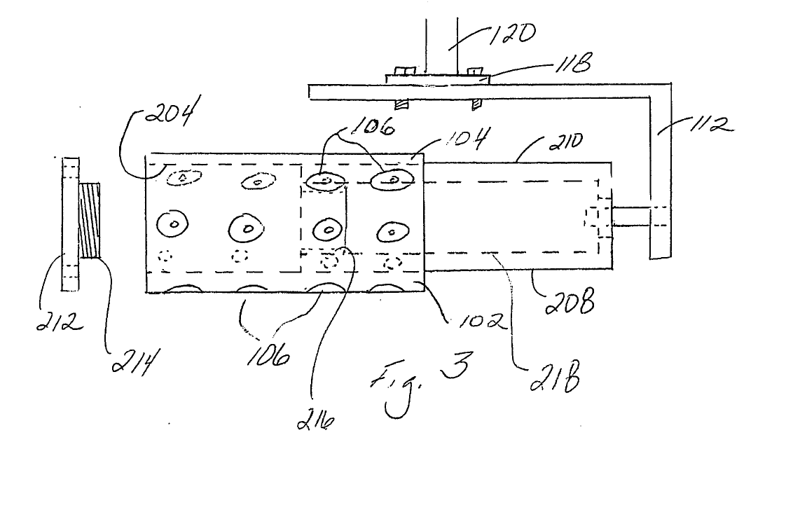

FIG. 3 illustrates a front view of a roller body 102 having a removable sleeve configuration according to an embodiment of the present invention. Such an embodiment may improve the ease with which a roller body 102 may be removed and replaced by another roller body 102 having different types of depressions or patterns. As illustrated in FIG. 3, the roller body 102 may include an outer surface 104 and inner surface 204. The outer surface 104 may include at least one depression 106. Portions of the outer surface 104 adjacent to the depressions 106 may be relatively smooth. In the illustrated embodiment, the outer surface 104 may not include any protrusions extending generally outwardly away from the outer surface 104. The inner surface 204 is configured for the placement of the roller body 102 about a spindle 208. The spindle 208 may have a generally cylindrical configuration, and may include a first surface 210 and a second surface 218. The first surface 210 may be sized to allow the inner surface 204 of the roller body 102 to slide into its operable position over the spindle 208. Alternatively, the spindle body 208 may be constructed from prongs, rods, or strips of material that extend from a first hub to a second hub, in which the prongs, rods, or strips of material are sized and oriented to at least partially abut against at least a portion of the inner surface 204 of the roller body 102.

The roller body 102 may be secured to the spindle 208 through the use of a variety of attachment mechanisms. For example, a threaded end cap 212 may be placed against an end of the roller body 102. The end cap 212 may have male threads 214 that operably connect the end cap 212 to the spindle 208, such as by interaction with mating female internal threads 216 that may be operably positioned along, or connected to, the second surface 218. In another embodiment, the end cap may be operably connected to spindle 208 by a tapered connection. Alternatively, at least one depression 106 may be configured to receive a screw, such as a set screw, that may be used to securely attach the roller body 102 to the spindle 208. Additionally, the roller body 102 may include an additional orifice that is configured to receive an attachment mechanism that may be used to connect roller body 102 to the spindle 208. In such an embodiment, once the attachment mechanism is positioned, and the roller body 102 is at least partially secured to the spindle 208, the orifice may be covered by a cap or temporarily filled so that the orifice does not act as an undesired depression when the roller body 102 is rolled in pre-cured concrete.

FIG. 4 illustrates a perspective view of a plurality of depressions 106 positioned along a metal sheet 10 that may be used in fabricating a roller body 102 according to an embodiment of the present invention. Although FIG. 4 illustrates a relatively flat or slightly bowed metal sheet 10, fabrication of the roller body 102 may involve the use of a variety of other processes or procedures, such as, but not limited to, casting a tubular body, rolled metal rings, forging, molding, and/or extrusion. Suitable materials also include, but are not limited to, metal, cast steel, aluminum, stainless steel, plastics, ceramics, and composites.

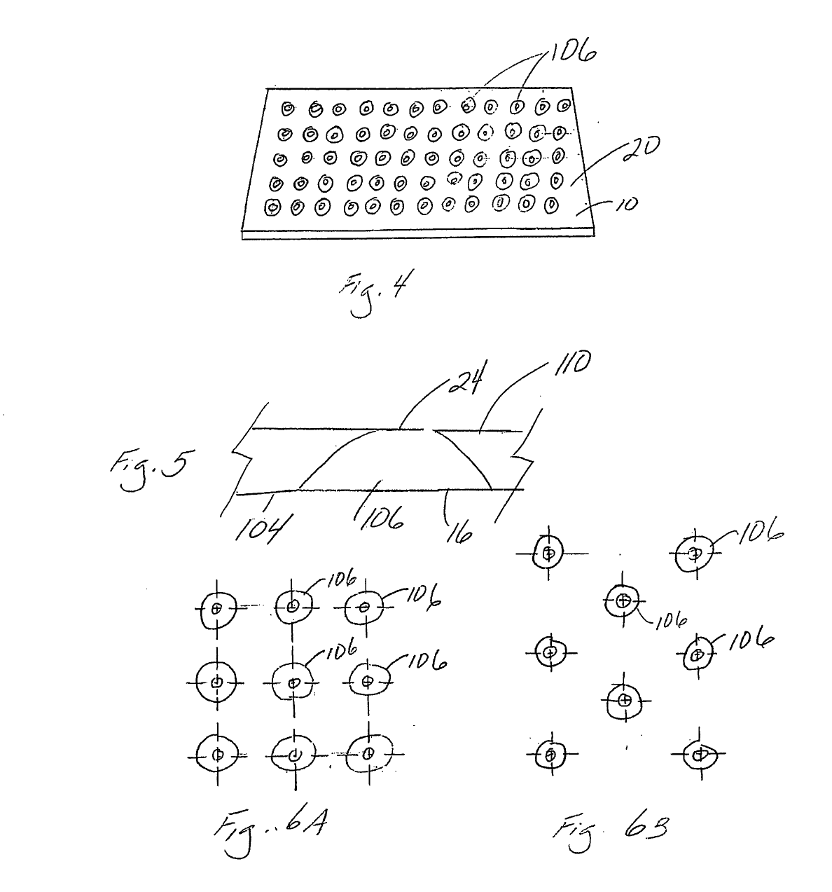

FIG. 5 illustrates a side cross-sectional view of an individual depression 106 having a dome-shaped configuration according to an embodiment of the present invention. In some embodiments, the depression(s) 106 may be created in the metal sheet 10 as shown in FIG. 4, or after the construction or fabrication of the roller body 102. The depression(s) 106 may be created through the use of a variety of processes, including, but not limited to, drilling, cutting, acetylene torches, plasma cutters, stamping, punches, reaming, and/or molding. In other embodiments, the depression 106 may be molded into the roller body 102.

In some embodiments, the desired size, shape, and configuration of the resulting texture in the concrete created by the use of the roller apparatus 100 may be determined by city, building, or construction codes or guidelines, such as the Americans with Disabilities Act Accessibility Guidelines. For example, such codes or guidelines may require or suggest that at least a portion of a textured concrete surface include raised truncated domes having a diameter around 23 mm, a height around nominal 5 mm, and center-to-center spacing of approximately 59 nominal mm. Further, these truncated domes may be placed 0.6 mm deep at the base of curb ramps, on the sidewalk edge of the street at blended curbs, and/or at flush transitions from the crosswalk to the sidewalk. In one embodiment, the alignment of the truncated domes may be parallel to the primary direction of travel.

As illustrated in FIG. 5, a depression 106 having a dome-shaped configuration may include an outer opening 16 along the outer surface 104, and a smaller inner opening 24 along the inner surface 110. The outer opening 16 may be in communication with the inner opening 24. However, alternative embodiments may not include the inner opening 24, in which case the depression 106 may be closed off from the inner portion 26 of the roller body 102.

Although FIG. 5 illustrates a depression 106 having a dome-shaped configuration, the depression 106 may have a variety of different shapes, including, but not limited to, at least partially rounded, nipple, square, rectangular, triangular, tapered, or trapezoidal. The depression may also be configured as one or more grooves that may extend along or across at least a portion of the outer surface 104. For example, the depression 106 may be a groove that goes around at least a portion of the outer surface 104 in a spiral direction or pattern. Further, the depression 106 may also be configured to provide information, such as, text, numbers, directions, location, trademarks, logos, advertising, or illustrations, or a combination of various types of information and/or shapes.

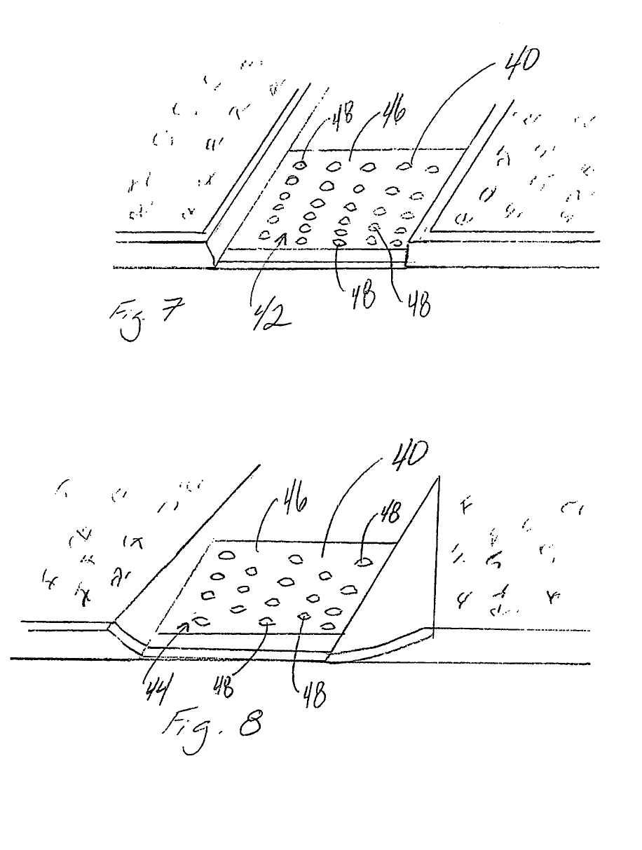

FIGS. 6A and 6B illustrate a plurality of depressions 106 arranged in square and triangular patterns, respectively, according to embodiments of the present invention. The orientation of the depressions 106 along the roller body 102 may be based on a number of factors, including the desired texture on the concrete surface, the size of the depressions 106, the desired number of depressions 106 in a given area, the purpose for creating the texture (i.e., ornamental or functional), and the size of the concrete surface.

FIGS. 7 and 8 illustrate perspective views of ramps having textured surfaces created using roller apparatuses with dome-shaped depressions arranged in rectangular and triangular patterns 42, 44, respectively, according to embodiments of the present invention. As shown, the square and triangular textured patterns 42, 44 in FIGS. 7 and 8 create a plurality of bumps 48 that were formed by pre-cured concrete that was pushed up into the dome-shaped depressions 106 in the roller body 102.

In use, the roller body 102 is operably connected to the attachment mechanism 112 and associated handle 120. Prior to application of the roller apparatus 100 of the present invention, the pre-cured cement may or may not already be generally smoothened or leveled. The roller body 102 is then rolled along or against the pre-cured cement. The weight of the roller apparatus 100 and/or force exerted generally downward against the roller apparatus 100 may force at least a portion of the pre-cured cement underneath the roller body 102 to go up into an adjacent depression 106 as the roller apparatus is rolled along or against the concrete surface. Preferably, the weight or force exerted generally downward on the pre-cured concrete beneath the roller body 102 should be sufficient so that the entire depression 106 may be filled with pre-cured cement. The pre-cured cement underneath roller body 102 that is not pushed up into a depression 106 may be flattened by the adjacent relatively smooth portions of the outer surface 104. As the roller body 102 continues to rotate across the pre-cured concrete surface, at least a portion of the concrete that has been pushed into the depression 106 will remain on the pre-cured concrete surface, and may have a shape that projects higher than the smoothened areas of the pre-cured concrete surface, and may also partially reflect at least a portion of the general shape of the depression 106. In instances in which the depression 106 includes an inner opening 24, the inner opening 24 may provide an outlet for excess cement to be released from inside the depression 106, wherein the excess cement may be collected or gathered within the inner portion 108 of the roller body 102.

While the invention has been described with reference to a preferred embodiment, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. An apparatus for creating textured concrete surfaces comprising:
a. a roller apparatus, said roller apparatus having a roller body, said roller body having an outer surface and an inner surface, said outer surface having at least one depression, the remainder of said outer surface having a relatively smooth surface, said outer surface not including protrusions that are intended to create impressions into the concrete surface, said at least one depression and said relatively smooth surface configured to form a textured surface on a concrete surface;
b. an attachment bracket operably connected to said roller apparatus; and
c. a handle operably connected to said attachment bracket.

2. The apparatus of claim 1 wherein at least one of said at least one depression has a dome-shaped configuration.

3. The apparatus of claim 1 wherein said at least one depression has an inner opening, said inner opening configured to allow excess pre-cured cement to flow into an inner portion of said roller body.

4. The apparatus of claim 1 wherein at least one of said at least one depression is configured to be a text character.

5. The apparatus of claim 1 wherein at least one of said at least one depression is configured to be a numerical character.

6. The apparatus of claim 1 wherein at least one of said at least one depression is configured to be a company logo.

7. The apparatus of claim 1 wherein said roller body includes an inner portion, said inner portion configured to receive the insertion of weights to increase the weight of said roller apparatus.

8. The apparatus of claim 1 wherein said roller body includes an inner portion, said inner portion including at least one compartment, said at least one compartment configured to contain a liquid, the liquid being added to said compartment to increase the weight of said roller apparatus.

9. The apparatus of claim 1 wherein said roller body includes an inner portion, said inner portion including at least one compartment, said at least one compartment configured to contain a solid material, the material being added to said compartment to increase the weight of said roller apparatus.

10. The apparatus of claim 1 having a plurality of depressions, said plurality of depressions being configured in a square pattern.

11. The apparatus of claim 1 having a plurality of depressions, said plurality of depressions being configured in a triangular pattern.

12. An apparatus for creating textured concrete surfaces comprising:
a. a roller apparatus, said roller apparatus having a roller body, said roller body having an outer surface and an inner surface, said outer surface having at least one depression, the remainder of said outer surface having a relatively smooth surface, said outer surface not including protrusions that are intended to create impressions into the concrete surface, said at least one depression and said relatively smooth surface configured to form a textured surface on a concrete surface;
b. a spindle, said spindle having a first surface and a second surface, at least a portion of said second surface configured for operable engagement with said inner surface of said roller body;
c. an attachment bracket operably connected to said spindle; and
d. a handle operably connected to said attachment bracket.

13. The apparatus of claim 12 wherein at least one of said at least one depression has a dome-shaped configuration.

14. The apparatus of claim 12 wherein said at least one depression has an inner opening, said inner opening configured to allow excess pre-cured cement to flow into an inner portion of said roller body.

15. The apparatus of claim 12 wherein at least one of said at least one depression is configured to be a text character.

16. The apparatus of claim 12 wherein at least one of said at least one depression is configured to be a numerical character.

17. The apparatus of claim 12 wherein at least one of said at least one depression is configured to be a company logo.

18. The apparatus of claim 12 having a plurality of depressions, said plurality of depressions being configured in a square pattern.

19. The apparatus of claim 12 having a plurality of depressions, said plurality of depressions being configured in a triangular pattern.

20. A method for creating textured concrete surfaces comprising:
a. rolling a roller apparatus against a pre-cured concrete surface, the roller apparatus having a roller body, said roller body having an outer surface, said outer surface including at least one depression, the remaining outer surface being a relatively smooth surface, said outer surface not including protrusions that are intended to create impressions into said concrete surface;
b. forcing at least a portion of the pre-cured concrete surface into at least a portion of said at least one depression, the force being applied to the concrete surface at least partially by the weight of said roller apparatus;
c. smoothing at least a portion of the pre-cured concrete surface that is not forced into said at least one depression; and
d. forming a textured surface on the concrete surface, the textured surface being created by at least a portion of the adjacent pre-cured concrete beneath said outer surface being pushed up into at least a portion of said at least one depression and at least a portion of the remaining concrete beneath said roller being relatively flattened smooth by the relatively smooth surface of said roller body as said roller body rolls across the pre-cured concrete surface, at least a portion of the pre-cured concrete pushed up into said at least one depression having a shape that projects higher than the smoothed areas of the pre-cured concrete surface and at least partially reflecting at least a portion of the general shape of the depression.
